(19) United States
(12) Patent Application Publication
(10) Pub. No.: US 2009/0236054 A1
(43) Pub. Date: Sep. 24, 2009

(54) WINDOWS FOR A ROLLUP DOOR

(76) Inventors: Carl David Hardison, III, Preston, IA (US); Thomas Jansen, Dubuque, IA (US); Peter S. Schulte, East Dubuque, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/050,717

(22) Filed: Mar. 18, 2008

(51) Int. Cl. E06B 9/56

(52) U.S. Cl. 160/330

(57) ABSTRACT

A fabric power door with a vertical or side-winding curtain includes window comprised of a transparent sheet that is attached to the curtain by way of a flexible frame. The transparent sheet is appreciably smaller than the window opening in the curtain to create a strain-relieving gap between the sheet and the curtain. The flexible frame extends across the gap and overlaps both the curtain and the transparent sheet. As the door opens and closes, the flexible frame protects the transparent sheet from stresses from the flexing movement of the curtain.

### FIELD OF THE DISCLOSURE

This disclosure relates generally to a fabric power door and more specifically to a flexible window for a door.

### BACKGROUND

Basically, there are two types of fabric power doors, those that have a curtain that moves generally vertically and those that move generally sideways. For vertically operating doors, a horizontal drum or roller above the doorway typically takes up or pays out a flexible curtain to respectively open or close the door. An example of such a vertically operating rollup door is shown in U.S. Pat. No. 7,151,450. Other vertically acting fabric power doors may have a fabric panel that does not roll up on a drum. For example, the fabric panel may take a spiral configuration in the stored open position, by being guided by spiral guideways at its edges, as it moves from the closed to the open position. Alternatively, the door may have a fabric panel that does not roll up or spiral at all, but rather maintains a generally planar configuration above the doorway when in the open position. Although stored this way, such doors still typically undergo some significant bending, such as a 45 or 90 degree turn around a roller as it moves between the open and closed positions.

Horizontally acting fabric power doors, such as the one disclosed in U.S. Pat. No. 4,096,902; typically include at least one flexible curtain wrapped around at least one vertical roller at a lateral edge of the doorway. A generally vertical leading edge of the curtain translates across the doorway to open or close the door. As with vertically acting doors, a rolled configuration of the stored panel is one among many possible.

To provide visibility through the curtain when the door is closed, often the curtain will include at least one window or “vision” panel. The window might be comprised of a transparent sheet of material that overlaps a window opening in the curtain. VELCRO or double-sided flexible tape between the overlapping sections of the sheet and the curtain can be used to hold the sheet in place.

The differing material properties of the curtain material, and the material forming the window can lead to undesirable degradation of the window over time. The curtain is typically formed of a fabric base with a flexible coating, while the window is usually a unitary material, such as urethane, vinyl, or a polycarbonate (such as LEXAN). In general, the heavy curtain material is stiffer and more resistant to bending than the material forming the window. Moreover, the different constituents of the curtain (base fabric, coating, etc.) may allow it to better handle and distribute the stresses induced thereon by door operation, such as, rolling or spiraling into a stored configuration, or bending around a roller as it moves between open and closed positions, as compared to the ability of the unitary material of the window to handle such stresses. As a result of these differing properties, it has been seen that the resulting stresses placed on the window can degrade the material, particularly in the area of the connection between the window and the curtain. Even the conventional presence of a flexible or resilient connection between the overlapping edges of the window opening in the curtain and the window material itself (the aforementioned tape or VELCRO connection) is not adequate to relieve the stress and tension on the window caused by the flexing (or the reduced amount of flexing) of the adjacent curtain material, leading to the window's undesirable degradation.

At the same time, the existing window materials have the desirable properties of providing a material both that provides adequate transparency, but that can handle being rolled or spiraled repeatedly. Some of the window materials, such as the LEXAN windows, are also more resistant to scratching (which can be desirable in a roll-up configuration where the window panels my rub together as they are wound onto the drum) and have better UV stability. The more flexible window materials (such as vinyl or urethane) also have desirable properties while maintaining adequate transparency. So, while the materials for fabric power door windows are acceptable for their purpose, their degradation owing to their differing material properties as compared to the remainder of the curtain limits their ability to provide a long-lasting clear window for the door.

### BRIEF DESCRIPTION OF THE DRAWINGS

FIG. 1 is a front view of a fabric power door in the form of a rollup door shown in a closed position.

FIG. 2 is a front view of the door of FIG. 1 but showing the door partially open.

FIG. 3 is a front view of the door of FIG. 1 but showing the door fully open.

FIG. 4 is a closer front view of the window installed on the door of FIG. 1.

FIG. 5 is a front view similar to FIG. 4 but showing some parts partially pulled away from the completed assembly.

FIG. 6 is a cross-sectional view taken along line 6-6 of FIG. 1.

FIG. 7 is a cross-sectional view similar to FIG. 6 with the components in an alternate arrangement.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

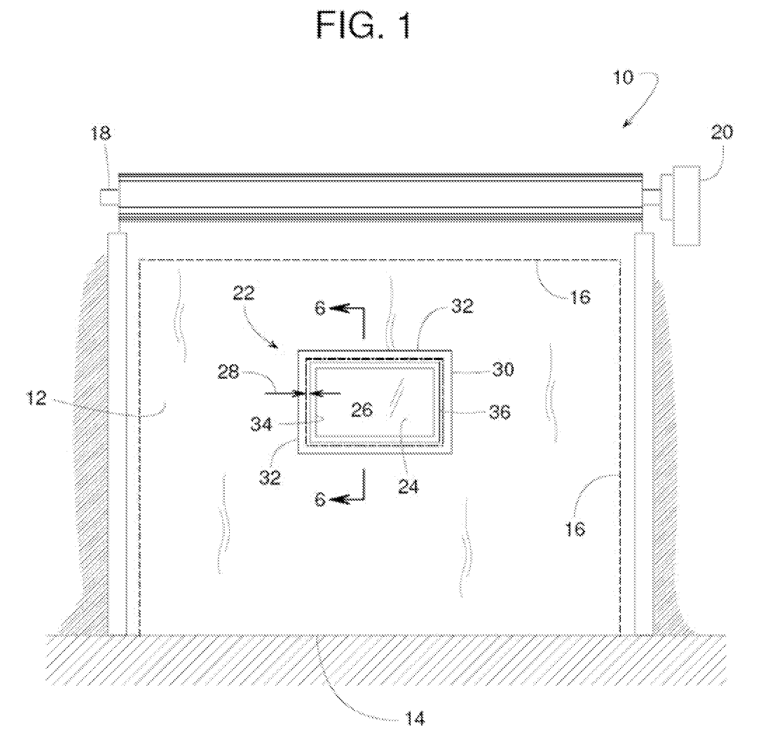

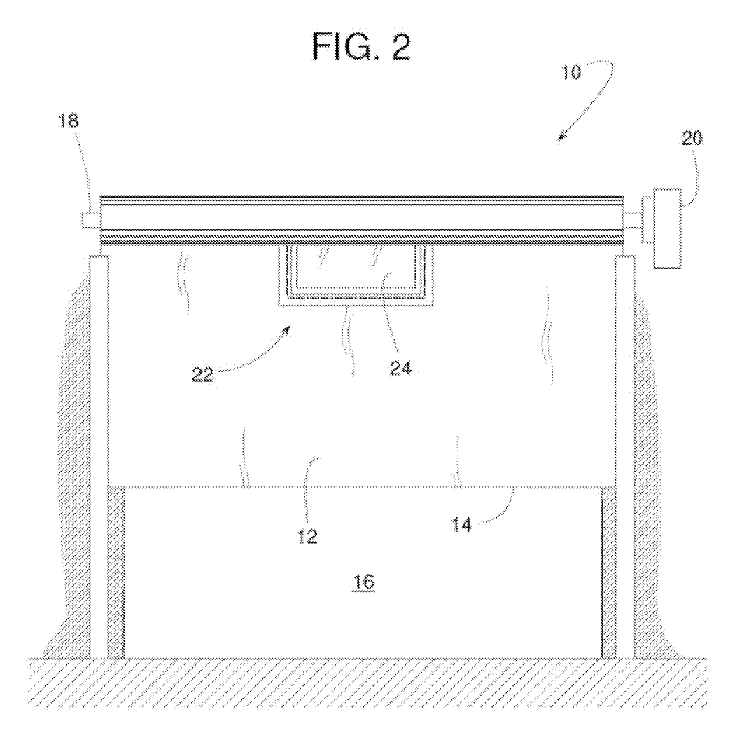

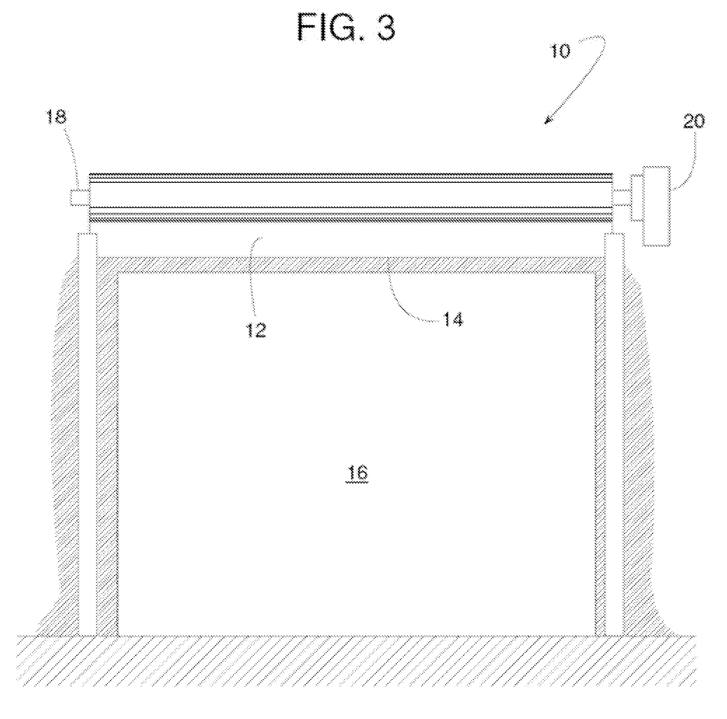

The illustrated examples of FIGS. 1-3 show a fabric power door in the form of a rollup door 10 with a curtain 12 having a leading edge 14 that translates at a doorway 16 to open and close the door 10. Other forms of vertically acting fabric power doors exist (the above-referenced spiral-storing doors, and those that store in a generally planar configuration) and would also benefit from the window construction to be described herein. Moreover, although leading edge 14 is horizontal and moves vertically, this disclosure further applies to horizontally acting fabric power doors where the leading edge is vertical and translates horizontally across the doorway. In any of these cases, the curtain 12 undergoes some bending stress, such as, the curtain 12 wrapping around a roller 18 that selectively takes up or pays out the curtain 12 to respectively open or close the door 10, or the curtain 12 coiling up into a stored configuration, or turning 45 or 90 degrees around the roller 18 as it is driven at its edges between open and closed positions. For the purposes of this description, such bending of the curtain 12 as it travels will be referred to as the curtain assuming “at least a partially curved configuration as it moves between open and closed positions.” Door 10, for example, includes the roller 18 that is driven by a motor 20. Depending on the motor's 20 direction of rotation, curtain 12 moves to either open or close the door 10. While the window construction 22 described herein could apply to any of this variety of fabric power doors, the roll-up style has been depicted as it may represent the most extreme case of the attendant stresses on the window, and its interface with the curtain 12 and its different material properties.

To provide visibility through the door when it is closed, door 10 includes the window construction 22 for use with a fabric power door. In the window construction 22, as shown in FIGS. 4-7, a transparent sheet 24 is installed within a window opening 26 in curtain 12. The term, “transparent” means that one can see through the material. Transparent does not necessarily mean perfectly clear, and the material could be tinted. The sheet 24 has some or all of the desirable properties for a window in a power door application, such as its transparency, combined with flexibility for rolling up, spiraling or bending; scratch resistance; UV stability, etc. In some cases, sheet 24 is made of polycarbonate, while curtain 12 is comprised of a nylon or polyester base material with a polypropylene coating. Materials other than polycarbonate and polypropylene coated base fabric are certainly possible, but the two materials will typically have different properties, such as resistance to bending (the curtain 12 is typically stiffer and more resistant to bending), and the ability to absorb and resist applied stresses due to door operation—with the curtain 12 material typically having better stress-resistance owing to the curtain 12 being made up of differing components as compared to the unitary material of the sheet 24.

To minimize the strain on sheet 24 caused by the differing flexibility and stress-resistance of curtain 12, sheet 24 is appreciably smaller than window opening 26 to create a strain-relieving gap 28 between the outer perimeter of sheet 24 and the edges of opening 26. To hold sheet 24 in place, a flexible frame 30 bridges gap 28 to couple sheet 24 to curtain 12 without overlap between the two, wherein frame 30 is preferably more flexible than at least curtain 12. In this example, frame 30 is made of a polyester base material coated with polyurethane with a material thickness that is less than that of at least curtain 12. This allows frame 30 to be less stiff and more flexible than the curtain material. At the same time, it also has the desirable stress-distribution properties of a fabric like the curtain, made up of a coated base material. Frame 30, thus, has the ability to handle and/or absorb the stresses that would otherwise be placed on the sheet 24 were it directly attached around its edges to the curtain 12 (e.g., stresses that are introduced to the curtain 12 during, for example, opening and/or closing). Frame 30, thus, serves some or all of several functions: bridging the physical gap between the sheet 24 and the larger window opening 26 in the curtain 12; creating a lateral perimeter connection between the sheet 24 and the curtain 12; and better absorbing stresses and forces that would otherwise have to be borne by the sheet 24 were it itself directly connected to the curtain 12, e.g., the frame 30 is a buffer or stress-absorbing structure between the window sheet 24 and the curtain 12. Frame 30 may be made of any other suitable material such as, for example, other flexible or stretchy materials (e.g., a resiliently stretchable knit fabric).

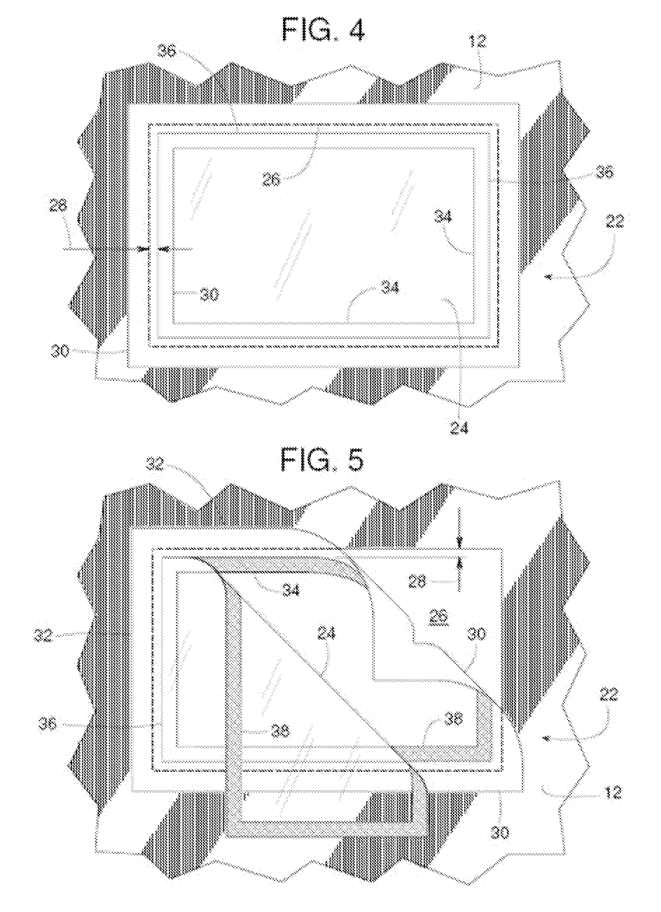

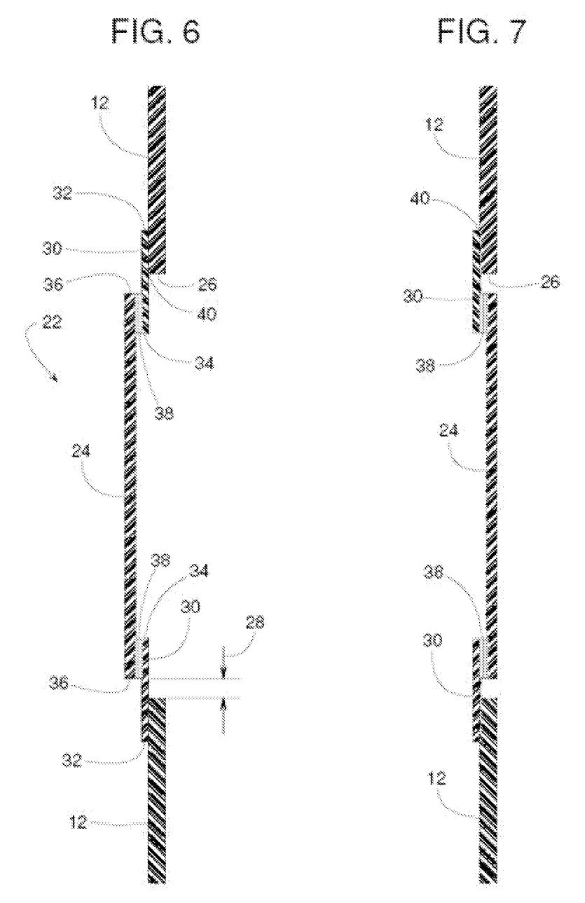

The actual assembly and construction of window 22 may vary. An outer perimeter 32 of frame 30, for instance, can be joined to curtain 12 in various ways including, but not limited to, adhesive bonding, thermal bonding, sonic welding, snaps, zipper, touch-and-hold fastener (e.g., VELCRO) and sewing. Likewise, an inner perimeter 34 of frame 30 can be joined to an outer edge 36 of sheet 24 in various ways including, but not limited to, adhesive bonding, thermal bonding, sonic welding, snaps, tape, zipper, touch-and-hold fastener (e.g., VELCRO) and sewing. In some cases, frame 30 is comprised of flexible adhesive tape. FIGS. 5 and 6 show a touch-and-hold fastener 38 that removably holds sheet 24 to frame 30, and a layer of adhesive 40 holds frame 30 to curtain 12. FIG. 7 shows an alternate assembly arrangement of sheet 24, frame 30 and curtain 12. As can be seen from the FIG. 7, the arrangement of FIG. 7 allows the window 24 to be substantially co-planar with the remainder of the curtain. Such an arrangement was not possible in previous configurations where the edge of the window overlapped with the curtain material surrounding the opening. This co-planar arrangement of window 22 and curtain 12 may also help reduce the stresses on the window that would otherwise be present if it were directly connected to the curtain 12.

At least some of the aforementioned examples include one or more features and/or benefits including, but not limited to, the following:

In some examples, a flexible frame couples a flexible transparent sheet to a door curtain having a window opening that is appreciably larger than the sheet.

In some examples, the frame is more flexible than the curtain.

In some examples, the frame is thinner than the curtain.

In some examples, the frame overlaps the transparent sheet and the curtain, but the transparent sheet does not overlap the curtain.

In some examples, the frame absorbs and/or reacts stresses that would otherwise be exerted on the sheet if it were directly attached to the curtain.

In some examples, the stress-resistance of the frame is provided by its being comprised of a coated base fabric.

In some examples, the sheet and surrounding curtain are coplanar, with the frame providing a perimeter lateral connection between the two.

Furthermore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A door movable between open and closed positions relative to a doorway, the door comprising:
a curtain that assumes at least a partially curved configuration as it moves between open and closed positions, the curtain defining a window opening;
a transparent sheet having a sheet outer perimeter that is smaller than the window opening; and
a frame coupling the transparent sheet to the curtain at the window opening, wherein the frame is more flexible than the curtain.

2. The door as defined in claim 1, wherein the transparent sheet is substantially co-planar with the curtain.

3. The door as defined in claim 1, wherein the transparent sheet is substantially scratch resistant.

4. The door as defined in claim 1, wherein the transparent sheet is substantially stable when exposed to U.V. light.

5. The door as defined in claim 1, wherein the transparent sheet comprises a polycarbonate based material.

6. The door as defined in claim 1, wherein the curtain comprises a nylon based material or a polyester based material that is coated with a coating that includes polypropylene.

7. The door as defined in claim 1, wherein the frame comprises of a polyester based material that is coated with a coating that includes polyurethane.

8. The door as defined in claim 1, wherein a thickness of the frame is less than a thickness of the curtain.

9. The door as defined in claim 1, wherein the frame is to partially absorb stresses and forces that are introduced to the curtain.

10. The door as defined in claim 1, wherein the frame is coupled to the curtain by at least one of adhesive bonding, thermal bonding, sonic welding, snaps, a zipper, a touch-and-hold fastener, or sewing.

11. The door as defined in claim 1, wherein the frame is coupled to the transparent window by at least one of adhesive bonding, thermal bonding, sonic welding, snaps, a zipper, a touch-and-hold fastener, or sewing.

12. A door movable between open and closed positions relative to a doorway, the door comprising:
a curtain having a first resistance to bending, and that assumes at least a partially curved configuration as it moves between open and closed positions, the curtain defining a window opening;
a transparent sheet having a second resistance to bending that is different than the first resistance, and a sheet outer perimeter that is smaller than the window opening; and
a frame coupling the transparent sheet to the curtain at the window opening, wherein the frame reacts stresses that would otherwise be induced in the sheet due to the difference between the first resistance and the second resistance.

13. The door as defined in claim 12, wherein a thickness of the frame is less than a thickness of the curtain.

14. The door as defined in claim 12, wherein the frame is to partially absorb stresses and forces that are introduced to the curtain.

15. The door as defined in claim 12, wherein the frame is coupled to the curtain by at least one of adhesive bonding, thermal bonding, sonic welding, snaps, a zipper, a touch-and-hold fastener, or sewing.

16. The door as defined in claim 12, wherein the frame is coupled to the transparent window by at least one of adhesive bonding, thermal bonding, sonic welding, snaps, a zipper, a touch-and-hold fastener, or sewing.

17. A door movable between open and closed positions relative to a doorway, the door comprising:
a curtain that assumes at least a partially curved configuration as it moves between open and closed positions, but which assumes a generally planar configuration in the closed position, the curtain defining a window opening;
a transparent sheet having a sheet outer perimeter that is smaller than the window opening, the sheet being disposed in a coplanar arrangement with the generally planar curtain; and
a perimeter connector extending laterally between the edge of the transparent sheet and the curtain at the window opening.

18. The door as defined in claim 17, wherein a thickness of the perimeter connector is less than a thickness of the curtain.

19. The door as defined in claim 17, wherein the perimeter connector is to partially absorb stresses and forces that are introduced to the curtain.
